(19) United States
(12) Patent Application Publication
(10) Pub. No.: US 2005/0059767 A1
(43) Pub. Date: Mar. 17, 2005

(54) Fuse for automobile

(76) Inventors: Makiko Saito, Nagoya-shi (JP); Yasuo Shimizu, Nagoya-shi (JP); Toru Nishimura, Nagoya-shi (JP); Norihiro Ohashi, Shizuoka-ken (JP); Hiroki Kondo, Shizuoka-ken (JP); Mika Suzuki, Shizuoka-ken (JP)

Correspondence Address: Kubovcik & Kubovcik;The Farragut Building, Suite 710, 900 17th Street NW, Washington, DC, 20006, US

(21) Appl. No.: 10/500,115

(22) PCT Filed: Dec. 27, 2002
(86) PCT No.: PCT/JP02/13748

(30) Foreign Application Priority Data
Dec. 27, 2001 (JP) 2001-397338

(51) Int. Cl. C08K 3/34

(52) U.S. Cl. 524/445

(57) ABSTRACT

A fuse for an automobile having a housing manufactured by the injection molding of a polyamide resin composition, wherein the polyamide resin composition constituting the housing has a heat of fusion of 40 J/g or more, as measured by means of a differential scanning calorimeter, and exhibits an average diameter of spherulites of 0.5 μm or less, as measured by the observation by means of a polarization optical microscope.

### BACKGROUND OF THE INVENTION

1. Field of the Invention

The present invention relates to a fuse for an automobile having a housing manufactured by the injection molding of a polyamide resin composition, more specifically, a fuse for an automobile with excellent transparency, arc and heat resistance, in particular, with transparency that does not deteriorate even if it is used in the high-temperature environment of the engine room of automobiles.

2. Detailed Description of the Prior Art

Fuses are installed in the circuits of electric components in automobiles to prevent overcurrents. The numbers of fuses being installed are increasing due to an increase in electric components. Conventionally, materials with excellent visibility (transparency) and heat resistance have been used for the housings of the fuses in automobiles. Polyethersulfone is one such material that has been used.

In recent years, the elevation of battery voltage for automobiles has come under review. For example, the adoption of 42V systems is now being discussed. However, the conventionally used polyethersulfone has poor arc resistance in 42V electric systems.

As substitute resins for polyethersulfone, crystalline polyamides such as nylon 6 and nylon 66 have excellent arc resistance, however, they are inferior to conventional materials in heat resistance and transparency. There is a known technology to mix fibrous reinforcing materials such as glass fibers or mineral reinforcing materials such as calcium carbonate and talc to enhance heat resistance. However, it is inevitable that transparency deteriorates in the polyamide resins mixed with these reinforcing materials because the light reflects diffusely due to the reinforcing materials dispersed in the polyamide resins.

Meanwhile, there is a known technology to reduce the crystalline property of polyamides by copolymerization to improve the transparency of polyamide resins. The technology is widely used in films where transparency is required. However, if the crystalline property is reduced, it is inevitable that strength and heat resistance deteriorate. The strength and the heat resistance can be enhanced by mixing the reinforcing materials as shown above. However, this is inevitably sacrifices the transparency to a large degree.

As a solution, there is a proposal that inorganic crystal components which are significantly finer than the conventional reinforcing materials are evenly dispersed in the polyamide. For example, the Japanese Patent Laid-Open No. HEI5-339498 (1993-339498) and No.2001-2913propose the polyamide resin compositions with excellent transparency and surface glaze made by dispersing phyllosilicate in copolymer polyamide resins. Though these copolymer polyamides have excellent transparency, they have problems in heat resistance. Therefore, they can not be used in high temperature environment such as engine rooms of automobiles for long periods of time.

### SUMMARY OF THE INVENTION

The purpose of the present invention is to offer a fuse for an automobile with heat resistance that can be used in the high temperature such as engine rooms of automobiles, transparency that enables the inside of the molded components to be seen and arc resistance. A fuse for an automobile in the present invention to achieve the purposes shown above has a housing manufactured by the injection molding of a polyamide resin composition, wherein the polyamide resin composition constituting the housing has a heat of fusion of 40 J/g or more, as measured by means of a differential scanning calorimeter, and exhibits an average diameter of spherulites of 0.51 μm or less, as measured by the observation by means of a polarization optical microscope.

Thus, it is possible to simultaneously enhance the heat resistance, transparency and arc resistance of the housing and, especially, maintain high transparency even when the fuse is used in high temperatures of engine rooms of automobiles by forming the housings with polyamide resin compositions having a specific degree of crystallization and diameter of spherulites.

The fuse for the automobile according to the present invention, more preferably, shall be configured so that:
(1) the rate of change in the heat of fusion when heat-treating at 130° C. for 30 minutes a polyamide resin composition molded body that forms the housing obtained by injection-molding at a mold temperature of 40° C. is less than 15%,
(2) the total light transmittance of a polyamide resin composition molded body that forms the housing obtained by injection-molding at a mold temperature of 70° C. is 80% or more compared to the total light transmittance of a molded body obtained by injection-molding at a mold temperature of 40° C.,
(3) the polyamide resin composition forming the housing is composed of polyamide resin (a) and swellable phyllosilicate (b),
(4) the polyamide resin (a) is at least one from group of nylon 6, nylon 66 and copolymer or mixture of the two,
(5) the polyamide resin is specifically nylon 6,
(6) the polyamide resin (a) is composed of a mixture of crystalline polyamide (c) and low-crystalline or amorphous polyamide (d),
(7) the exchangeable cations existing between the layers of the swellable phyllosilicate (b) are swellable phyllosilicate exchanged with organic onium ions,
(8) the swellable phyllosilicate (b) is montmorillonite,
(9)the swellable phyllosilicate (b) is dispersed in the polyamide resin compositions on the monolayer level,
(10) the polyamide resin composition includes a crystal nucleating agent (e), and
(11) the swellable phyllosilicate (b) is introduced in the polyamide resin composition by using a melt kneading method.

### BRIEF DESCRIPTION OF THE DRAWINGS

The drawing is a perspective view of an example of the fuse for the automobile according to the present invention.

### DETAILED DESCRIPTION OF THE PREFERRED EMBODIMENT

The size and shape of the fuse for the automobile according to the present invention are not particularly limited if it is used on the way of the electric components of automobiles. However, at least a part of the housing shall be injection-molded with a polyamide resin composition with a specific heat of crystal melting and diameter of spherulites as described below.

A fuse 1 for an automobile shown in the drawing is composed of a housing 2 injection-molded with a polyamide resin composition with a specific heat of crystal melting and a diameter of spherulites as described above, and a pair of terminal 3 and 4 inserted into the housing 2. The housing 2 has heat resistance to make the fuse usable for long periods of time, transparency to make the inside of molded components visible, and arc resistance even in the high-temperature environment of the engine rooms of automobiles because the housing is composed of the polyamide resin composition with the specific heat of crystal melting and the diameter of spherulites.

The polyamide resin composition constituting the housing has the heat of fusion of 40 J/g or more, preferably, 50 J/g or more, as measured by means of a differential scanning calorimeter (DSC) at a heating rate 10° C./min. If the heat of fusion is 40 J/g or less, the transparency may deteriorates or the fuse may be deformed in higher temperature for long term use. The upper value of the heat of fusion is not particularly limited. However, it is preferably 70 J/g or less.

In this case, the heat of fusion of the polyamide resin composition is the value by means of DSC measurements after a vacuum drying at 80° C. for more than 10 hours if the housing absorbed water.

The average diameter of spherulites of the polyamide resin composition forming the housing is required to be 0.5 μm or less, preferably, 0.3 μm or less. If the diameter of spherulites exceeds 0.5 μm, the transparency deteriorates because the light reflects diffusely due to the spherulites. The lower value of the diameter of spherulites is not particularly limited. However, generally, it is desirable to set the limit to about 0.01 μm. The diameter of spherulites used here is the value that is obtained by averaging the diameters of spherulites with an image analysis device after cutting ultra-thin sections from the housing composed of the polyamide resin composition, observing the sections with a polarization microscope or a transmission electron microscope and taking pictures of the spherulites.

In the present invention, the rate of change in the heat of fusion is more preferably is less than 15% between immediately after obtaining the housing by injection molding a polyamide resin composition at mold temperature of 40° C. and after heat treating the housing at 130° C. for 30 minutes.

The polyamide resin composition used for the fuse for the automobile according to the present invention is not limited if it has the specific heat of fusion and size of spherulites. More specifically, the polyamide resin composition is preferably composed of polyamide resin (a) and swellable phyllosilicate (b).

The polyamide resin (a) used in the present invention is a copolymer with amide bond primarily made from amino acid, lactam or diamine and carboxylic acid. The polyamide resin (a) is not particularly limited. Polyamides made from any amino acids, lactam or diamine and carboxylic acids can be used. Specifically, the main component is preferably crystalline polyamide resin (c).

The crystalline polyamide (c) means a crystalline polyamide with a heat of fusion of 30 J/g or more measured at heating rate 10° C./min with a differential scanning calorimeter (DSC). Polyamide resins are not particularly limited if they have the crystalline properties shown above.

Specific examples of the starting materials include amino acids such as 6-aminocaproic acid, 11-aminoundecanoic acid, 12-aminododecanoic acid, para-aminomethylbenzoic acid, etc.; lactams such as e-caprolactam, ω-laurolactam, etc.; aliphatic, alicyclic or aromatic diamines such as tetramethylenediamine, hexamethylenediamine, 2-methylpentamethylenediamine, undecamethylenediamine, dodecamethylenediamine, 2,2,4-/2,4,4-trimethylhexamethylenediamine, 5-methylnonamethylenediamine, metaxylylenediamine, paraxylylenediamine, 1,3-bis(aminomethyl)cyclohexane, 1,4-bis(aminomethyl)cyclohexane, 1-amino-3-aminomethyl- 3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, aminoethylpiperazine, etc.; aliphatic, alicyclic or aromatic dicarboxylic acids such as adipic acid, suberic acid, azelaic acid, sebacic acid, dodecane-diacid, terephthalic acid, isophthalic acid, 2-chloroterephthalic acid, 2-methylterephthalic acid, 5-methylisophthalic acid, 5-sodium-sulfoisophthalic acid, hexahydroterephthalic acid, hexahydroisophthalic acid, etc.

In the present invention, a polyamidehomopolymer or a copolymer derived from these materials alone or mixture thereof may be used.

The crystalline polyamide resins preferably used in this invention is polyamide resins with the melting point of 200° C. or higher. The molded bodies obtained by using these polyamides can have excellent heat resistance and strength. Specific examples of polyamide resins include polycaproamide (nylon 6), polyhexamethylene adipamide (nylon 66), polycaproamide/ polyhexamethylene adipamide copolymer (nylon 66/6), polytetramethylene adipamide (nylon 46), polyhexamethylene sebacamide (nylon 610), polyhexamethylene decamide (nylon 612), polyhexamethyleneterephtalamide/polydodecamide copolymer (nylon 6T/12), polyhexamethylenadipamide/polyhexamethylene terephthalamide copolymer (nylon 66/6T), and their mixtures and copolymers. Of those, preferred are nylon6, nylon 66, nylon 6/66 copolymers, etc.

The degree of polymerization of crystalline polyamides is not limited specifically if normal molding processes are possible. However, it is preferable that the relative viscosity of polyamide resin 1% by weight measured in 98% concentrated sulfuric acid solution at 25° C. is in the range from 2.0 to 4.0.

According to the present invention, the polyamide resin (a) is preferably a mixture of crystalline polyamide (c) and low-crystalline or amorphous polyamide (d).

The low-crystalline or amorphous polyamide (d) mean low-crystalline polyamides where the difference (Tm-Tc) between the melting point (Tm) measured at a heating and cooling rate of 10° C./min with a differential scanning calorimeter (DSC) and the crystallization temperature (Tc) at cooling is 40° C. or more, or amorphous polyamides where a heat of fusion measured at a heating rate 10° C./min with a differential scanning calorimeter is under 4 J/g.

The types of low crystalline or amorphous polyamides are not particularly limited. Polyamides made from any amino acids, lactam or diamine and dicarboxylic acid can be used. Specific examples of the starting materials include amino acids such as 6-aminocaproic acid, 11-aminoundecanoic acid, 12-aminododecanoic acid, para-aminomethylbenzoic acid, etc.; lactams such as e-caprolactam, ω-laurolactam, etc.; aliphatic, alicyclic or aromatic diamines such as tetramethylenediamine, hexamethylenediamine, 2-methylpentamethylenediamine, undecamethylenediamine, dodecamethylenediamine, 2,2,4-/2,4,4-trimethylhexamethylenediamine, 5-methylnonamethylenediamine, metaxylylenediamine, p araxylylenediamine, 1,3-bis(aminomethyl)cyclohexane, 1,4-bis(aminomethyl)cyclohexane, 1-amino- 3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, aminoethylpiperazine, etc.; aliphatic, alicyclic or aromatic dicarboxylic acids such as adipic acid, suberic acid, azelaic acid, sebacic acid, dodecane-diacid, terephthalic acid, isophthalic acid, 2-chloroterephthalic acid, 2-methylterephthalic acid, 5-methylisophthalic acid, 5-sodium-sulfoisophthalic acid, hexahydroterephthalic acid, hexahydroisophthalic acid, etc.

Of those, polyamides including compounds as raw materials having aromatic rings or alicyclic structure such as terephthalic acids, isophthalic acids, metaxylylenediamine, paraxylylenediamine, bis(4-aminocyclohexyl)methane, bis(3-methyl-4-aminocyclohexyl)methane are preferred.

In the present invention, particularly the useful low-crystalline or amorphous polyamides are those that have aromatic rings or alicyclic structure units in the principal chain. The specific examples of them include polymethaxylylene adipamide (nylon MXD 6), polyhexamethylene adipamide/polyhexamethyleneisophthalamide copolymer (nylon 66/6I), polycaproamide/polyhexamethyleneisophthalamide copolymer (nylon 6/6I), polyhexamethyleneterephthalamide/polyhexamethyleneisophthalamide copolymer (nylon 6T/61), polyhexamethylene adipamide/polyhexamethyleneterephthalamide/polyhexamethyleneisophthalamide copolymer (nylon66/6T/6I), polyhexamethylene adipamide/polyhexamethyleneisophthalamide/polycaproamide polymer (nylon66/6I/6) and polyhexamethyleneterephthalamide/polyhexamethyleneisophthalamide/polyhexamethylene adipamide copolymer (nylon6T/6I/66), etc.

Among them, nylon 66/6I and nylon 66/6I/6, etc are the most preferable.

The low-crystalline or amorphous polyamides (b) used in the present invention preferably include 3 to 30% by weight of hexamethyleneisophthalamide unit, and more preferably, 10 to 20% by weight.

If the polyamide used in the present invention is composed of a mixture of two or more polyamides, 1 to 20% by weight, and preferably 2 to 15% the hexamethyleneisophtalamide unit should be included in the mixture of two or more polyamides. The more preferable polyamide is a copolymerized polyamide including 3 to 30% by weight of hexamethyleneisophthalamide unit and 70 to 97% by weight of hexamethyleneadibamide unit. The further preferable polyamide is a copolymerized polyamide composed of 3 to 30% by weight of hexamethylenephthalamide unit and 60 to 96% by weight of hexamethyleneadipamide unit and 1 to 10% by weight of caproamide unit.

The degree of polymerization of low-crystalline or amorphous polyamides is not limited specifically if normal molding processes are possible. However, it is preferable that the relative viscosity of a polyamide resin 1% by weight measured in 98% concentrated sulfuric acid solution at 25° C. is in the range from 2.0 to 4.0.

In the polyamide resin used in this prevention, with regard to the mixing ratio of the crystalline polyamide (c) and the low-crystalline or amorphous polyamide (d), when the total polyamide resin component is 100% by weight, the crystalline polyamide (c) is 70 to 100% by weight, or preferably 80 to 95% by weight, and low-crystalline or amorphous polyamide (d) is 0 to 40% by weight or preferably 5 to 20% by weight. Higher balances between heat resistance and transparency can be established by using a low-crystalline or amorphous polyamide (d) in combination with a crystalline polyamide (c).

The swellable phyllosilicate used as component (b) in this invention has 2:1 structure where an octahedral sheet including metals such as aluminum, magnesium, lithium, etc is sandwiched between two silicate tetrahedral sheets to form a plate crystal layer. In general, there are exchangeable positive ions between layers of the plate crystal layer.

In general, the size of a plate crystal is 0.05 to 0.5 μm in width and 6 to 15 angstrom in thickness. The cation-exchange capacity of the exchangeable cation is 0.2 to 3 meq/g, and preferably 0.8 to 1.5 meq/g.

Specific examples of the phyllosilicate include a smectites clay mineral group such as montmorillonite, beidellite, nontronite, saponite, hectorite and sauconite; a clay mineral group such as vermiculite, halloysite, kanemite, kenyte, zirconium phosphate, titanium phosphate; a swellable mica group such as Li-fluoro taeniolite, Na-fluoro teniolite, Na-fluoro-mica tetrasilicide, Li-fluoro-mica tetrasilicide, etc. These may be a natural or synthesized.

Of those, a smectites clay mineral group such as montmorillonite and hectorite, a swellable mica group such as Na-fluoro-mica tetrasilicide and Li-fluoro taeniolite are preferable. Especially, montmorillonite is the most preferable.

In this invention, a phyllosilicate where exchangeable positive ions existing between layers are exchanged with organic onium ions is preferably used.

Organic onium ions usable here include ammonium ion, phosphonium ion, sulfonium ion, etc. Of those, ammonium ion and phosphonium ion are preferably used. Ammonium ion may be any one of primary, secondary, third and quaternary ammonium.

Primary ammonium ions include decyl ammonium, dodecyl ammonium, octadecyl ammonium, oleyl ammonium and benzyl ammonium, etc.

Secondary ammonium ions include methyldecyl ammonium, methyldodecyl ammonium and methyloctadecyl ammonium, etc.

Third ammonium ions include dimethyldodecyl ammonium and dimethyloctadecyl ammonium etc.

Quaternary ammonium ions include benzyltri alkyl ammonium ions such as benzyltrimethyl ammonium, benzyltriethyl ammonium, benzyltributyl ammonium, benzyldimethyldecyl ammonium, benzyldimethyloctadecyl ammonium; alkyltrimethyl ammonium ions such as trimethyloctyl ammonium, trimethldodecyl ammonium, trimethyloctadecyl ammonium; dimethyldialkyl ammonium ions such as dimethyloctyl ammonium, dimethyldodecyl ammonium, dimethyldioctadecyl ammonium; trialkylmethylammonium ions such as trioclylmethyl ammonium, tridodecylmethyl ammonium, etc.

In addition to them, ammonium ion derived from aniline, p-phenylenediamine, a-naphthylamine, p-aminodimethylaniline, penzidine, pyridine, piperidine 6-aminocaproic acid, 11-aminoundecanoic acid, 12-aminododecanoic acid or the like may be included.

Of those ammonium ions, quaternary ammonium ions are preferable. Specific examples inlcude ammonium ions derived from trioctylmethylammonium, trimethyloctadecyl ammonium, benzyldimethyloctadecyl ammonium and 12-aminododecanoic acid. Especially, trioctylmethyl ammonium and benzyldimethyl ammonium are the most preferable.

In the present invention, the phyllosilicate where the exchangeable cations existing between layers are exchanged with organic onium ions can be manufactured by reacting the phyllosilicate having exchangeable cations between layers with the organic onium ions by known methods. Specifically, the methods include a method by the ion-exchange reaction in the polar solvents such as water, methanol, ethanol, and methods to make the liquid or the dissolved ammonium salt react with the phyllosilicate directly.

With regard to the amount of organic onium ions to the phyllosilicate in the present invention, from the viewpoints of dispersibility of phyllosilicate, thermal stability when, melted, gas when molded, suppression of odor developoment, etc, the amount of organic onium ions is, in general, 0.4 to 2.0 equivalent weight to the cation exchange capacity of phyllosilicate. Particularly, 0.8 to 1.2 equivalent weight is preferable.

These phyllosilicates are preferably used by preliminary treatments with coupling agents having reactive functional groups as well as the organic onium salts shown above to obtain better mechanical strength.

These coupling agents include isocyanate compounds, organic silane compounds, organic titanate compounds, organic borane compounds, epoxy compounds, etc.

As the coupling agent, preferred are organic silane compounds (silane coupling agents), and their specific examples include epoxy group-having alkoxysilane compounds such as y-glycidoxypropyltrimethoxysilane, y-glycidoxypropyltriethoxysilane, β-(3,4-epoxycyclohexyl)ethyltrimethoxysilane, etc.; mercapto group-having alkoxysilane compounds such as y-mercaptopropyltrimethoxysilane, y-mercaptopropyltriethoxysilane, etc.; ureido group-having alkoxysilane compounds such as y-ureidopropyltriethoxysilane, y-ureidopropyltrimethoxysilane, y-(2-ureidoethyl)aminopropyltrimethoxysilane, etc.; isocyanato group-having alkoxysilane compounds such as y-isocyanatopropyltriethoxysilane, y-isocyanatopropyltrimethoxysilane, y-isocyanatopropylmethyldimethoxysilane, y-isocyanatopropylmethyldiethoxysilane, y-isocyanatopropylethyldimethoxysilane, y-isocyanatopropylethyldiethoxysilane, etc.; amino group-having alkoxysilane compounds such as y-(2-aminoethyl)aminopropylmethyldimethoxysilane, y- (2-aminoethyl)aminopropyltrimethoxysilane, y-aminopropyltrimethoxysilane, etc.; hydroxyl group-having alkoxysilane compounds such as y-hydroxypropyltrimethoxysilane, y-hydroxypropyltriethoxysilane, etc.; carbon-carbon unsaturated group-having alkoxysilane compounds such as y-methacryloxypropyltrimethoxysilane, vinyltrimethoxysilane, N-β-(N-vinylbenzylaminoethyl)-y-aminopropyltrimethoxysilane hydrochloride, etc. Especially preferred are carbon-carbon unsaturated bond-having alkoxysilane compounds.

For processing phyllosilicates with any of these coupling agents, a method of making the phyllosilicate absorb a coupling agent in a polar solvent of water, methanol, ethanol or the like or in a mixed solvent thereof, a method of making the phyllosilicate adsorb a coupling agent by dropping the agent with stirring the phyllosilicate in a high-speed stirring mixer such as a Henschel mixer; or a method of making the phyllosilicate adsorb the silane coupling agent by adding the agent to the phyllosilicate directly and mixing them in a mortar or the like: any of above methods can be used. While phyllosilicates are processed with a coupling agent, it is desirable to mix water, acidic water, alkaline water or the like at the same time so as to promote the hydrolysis of the alkoxy group in the coupling agent. In this case, in addition to water, an organic solvent such as methanol, ethanol or the like capable of dissolving both water and the coupling agent may be added to the system to increase the reactivity of the coupling agent. Heating the phyllosilicates processed with the coupling agent in this way makes possible to promote its reaction further.

When manufacturing the compounds in the present invention by melting and kneading phyllosilicates and polyamide resins, without previously processing phyllosilicates with a coupling agent, an integral blending method of adding these coupling agents in melting and kneading the phyllosilicate and the polyamide resin may be used.

In the invention, the order of the step of processing phyllosilicates with organic onium ions and the step of processing them with a coupling agent is not specifically defined. However, following processing phyllosilicates first with organic onium ions, processing them with a coupling agent is preferable.

The amount of the swellable phyllosilicate (b) of the invention may fall in the range from 0.1 to 20% by weight in terms of the amount of the inorganic ash content of the polyamide resin composition of the invention, but preferably in the range from 0.5 to 15% by weight. Even more preferably, it falls in the range from 1 to 10% by weight. If the amount of the ash content is too small, the heat resistance and the transparency of the molded products may degrade. If the amount of the ash content is too large, the toughness may degrade. The amount of the inorganic ash content may be determined by ashing 2 g of the polyamide resin composition in an electric furnace at 600° C. for 3 hours.

In the polyamide resin composition used in the present invention, the_phyllosilicates are preferably dispersed evenly in the polyamide resin composition as a matrix on the monolayer level. The dispersion evenly in the monolayer level means that the phyllosilicates are dispersed entirely in the matrix resin in one to ten layers or so without secondary aggregations. The state can be confirmed by cutting samples from the polyamide resin composition and observing them with an electron microscope.

The polyamide resin composition used in the invention may be optionally added a crystal nucleating agent (e) to in order to regulate the crystallinity. The crystal nucleating agents are not limited. Specific examples include inorganic particles such as talc, silica, graphite; metal oxides such as magnesium oxide and aluminum oxide; polyamideoligomer such as caprolactam duplicitas; high-melting point polyamides such as nylon 6T, nylon 66/6T, etc.

Of those, inorganic particles such as talc, silica, etc are preferable. Talc is still preferable. If the crystal nucleating agent is added, the amount of one, preferably falls in the range from 0.01 to 10 parts by weight, more preferably in the range from 0.03 to 5 parts by weight, further preferably in the range from 0.05 to 3 parts by weight relative to 100 parts by weight of the polyamide resin composition.

The polyamide resin composition of the invention may be optionally added any known additives of, in the range that they do not impair the effects of the present invention, for example, antioxidants and heat-resisting agents (hindered phenol system stabilizer, hydroquinone system stabilizer, phosphite system stabilizer, and these substituted stabilizers, etc.), to prevent yellowing or discoloration phosphorus compounds, weather-resistant agents (resorcinol system stabilizer, salicylate system stabilizer, benzotriazole system stabilizer, benzophenone system stabilizer, hindered amine system stabilizer, etc.), mold-releasing agents and lubricants (montanic acid and its metal salts, its esters, its half esters, stearyl alcohol, stearamide, various bisamides, bisurea, polyethylene wax, etc.), pigment (cadmium sulfide, Phthalocyanine, carbon black, metallic pigments, etc.), dye (Nigrosine, etc.), plasticizers (p-oxybenzoic acid octyl, N-butylbenzenesulfoneamide, etc), antistatic agents (nonionic antistatic agents such as alkyl sulphate anion antistatic agents, quaternary ammonium salt cation antistatic agents, polyoxyethylene sorbitan monostearate; betaine amphoteric antistatic agents, etc), fire retardants (red phosphorus, melaminecyanolate, hydroxides such as magnesium hydrate, aluminum hydroxide, etc., ammonium polyphosphate, brominated polystylene, brominated PPO, brominated PC, brominated epoxy resin or combinations of these bromine system fire retardants and antimon trioxide), other polymer (polyester, polycarbonate, polyphenylene ether, polyphenylene sulfide, polyether sulfone, ABS resin, SAN resin, polystyrene, acrylic resin, polyethylene, polypropylene, SBS, SEBS, varied elastomers, etc.).

The methods to obtain the polyamide resin compounds used in the present invention are not particularly limited. For example, phyllosilicates may exist when polymerizing polyamides but more preferable method is to melt-blend polyamide resins and phyllosilicates. In this case, the method to melt-blend polyamide resins and phyllosilicates are not particularly limited if mechanical shearing is possible when polyamide resins are melted. The processing method may be either the batch process or continuous process. The continuous method to manufacture continuously is more preferable from the viewpoint of operating efficiency.

Although there is no limitation for a specific mixer in use, an extruder, especially, a twin screw extruder is preferable from a viewpoint of proficiency. In order to remove water and low molecular weight volatile substances which are generated during melt-blending, vent ports are preferably arranged. In the case a twin screw extruder is used, the supply method of materials and agents may be either by supplying the mixture of polyamide resin (a) and phyllosilicate (b) mixed in a blender or the likes in advance from a feed port of the extruder, or by supplying polyamide resin (a) from a feed port upstream of the extruder and a phyllosilicate (b) and crystal nucleating agents (e) from a feed port downstream of the extruder. The method to supply is not particularly limited. The arrangement of screws of the extruder is not also limited, but a kneading zone is preferably arranged to disperse phyllosilicate into a monolayer level.

In order to disperse phyllosilicate, after manufacturing a master batch by melt-blending a part of polyamide resin (a) and phyllosilicate (b), melt-blending again with the remainder of the polyamide is preferable.

The polyamide resin composition used in the present invention is used for forming a housing part of a fuse by injection-molding. Obtained molded products have excellent transparency and heat resistance. The molded products of polyamide resin compositions according to the present invention can be processed afterward by cutting and varied welding.

As shown above, since the fuse for the automobile of the invention is made with its housing parts formed by polyamide resin compositions having a specific degree of crystallization and diameter of spherulites, the heat resistance, transparency and arc resistance are excellent at the same time, especially it is possible to prevent the transparency from deteriorating by using even for a long period of time under high temperature in an engine room of an automobile.

The invention is described more specifically with reference to the following Examples, which, however, are not intended to restrict the scope of the invention. The evaluation items in the embodiments and comparative examples were measured according to the methods mentioned below.

[Heat of crystal fusion(products molded at mold temperature 40° C.)]:

A part of thin and transparent areas of a fuse housing injection-molded at mold temperature 40° C. was sampled and measured using a differential scanning calorimeter (DSC) available from Seiko Instruments Inc. The heat of fusion was also measured by the same method after heat-treating the molded samples shown above at 130° C. for 30 minutes.

[Diameter of spherulites]:

Ultra-thin sections were cut out from a thin and transparent part of the fuse housing. Using an image analysis device, average diameter of spheruhites were calculated from the pictures of spherulites taken with a polarization optic microscope.

[Total light transmittance]

Total light transmittances of square plates with a size of 80 mm×80 mm×1 mm (depth×width×thickness), which were injection-molded at mold temperature of 40° C. and 70° C. respectively, were measured using a direct reading hazemeter available from Toyo Seiki Seisaku-Sho Ltd. Total light transmittances of molded plates obtained at mold temperature of 40° C. were also measured in the same method after heat-treating at 130° C. for 30 minutes.

[Load deflection temperature]:

Load deflection temperature was measured at a load of 0.46 MPa according to ASTM D648.

[Clay dispersibility ]

Ultra-thin samples were cut out from a thin and transparent part of the fuse housing to conduct visual evaluation of clay dispersibility using a transmission electron microscope.

The criteria for visual evaluation were as follows.

⊚:Clay is dispersed evenly in monolayer to several layers.

◯: Clay is dispersed evenly in monolayer to ten layers.

Δ: In some areas, clay is dispersed evenly in monolayer to ten layers.

However, aggregation of ten layers or more also exists.

x :Clay exists in aggregation of ten layers or more.

[Arc resistance]:

ASTM No.1 dumbbell test pieces were molded at mold temperature of 70° C. Arc resistance was measured using an arc resistance tester manufactured by Tokyo Seiden Company Limited according to ASTM D495.

Reference example 1 (manufacturing of low-crystalline polyamide)

75 part by weight of equimolal salt of hexamethylenediamine and adipic acid, 20 part by weight of equimolal salt of hexamethylene diamine and isophthalic acid and 5 part of e-caprolactam by weight were put into a reactor and then the same amount of pure water as all materials poured in was added. After the reactor was well replaced with nitrogen, heating was started while stirring. The final target temperature was set to 270° C. adjusting the pressure in the reactor at a maximum 2.0 MPa. The polymer discharged into the water bath was pelletized with a strand cutter to obtain low-crystalline polyamide (d-1).

The relative viscosity of the obtained low-crystalline polyamide in a concentrated sulfuric acid at 25° C. with a concentration of 1% was 2.30. The melting point (Tm) and temperature-falling crystallization temperature (Tc) measured with a differential scanning calorimeter were 233° C. and 176° C. respectively.

Reference example 2 (manufacture of swellable phyllosilicate)

After Na-montmorillonite (Kunimine Industries Co., Ltd.: Kunipia F, cation exchange capacity 120 m equivalent/100 g) of 100 g was put into ten liters of warm water to be stirred and dispersed, two liters of warm water in which benzyldimethyloctadecylammonium chloride (equivalent amount of cation exchange capacity) of 51 g was dissolved was added to it and stirred for one hour. Generated precipitation was filtered and then washed with warm water. After repeating the washing and the filtration three times, obtained solid matter was vacuum-dried at 80° C. to obtain dried swellable phyllosilicate (b). The measurement value of the inorganic ash content of the obtained swellable phyllosilicate was 68 weight %. The measurement value of the inorganic ash content was obtained by ashing the swellable phyllosilicate of 0.1 g in an electric furnace at 600° C. for 3 hours.

### EXAMPLE 1

A polyamide (c-1: nylon 6 with a relative viscosity of 2.70 measured at a concentration of 1% in concentrated suluric acid at 25° C.) and 3 part of swellable phyllosilicate by weight (b) obtained in the reference example 2 were mixed and pre-blended with a tumbler mixer, then they were melt-blended with TEX-30 twin screw extruder (The Japan Steel Works, Ltd.) setting the cylinder temperature to 250° C. to obtain polyamide resin composition.

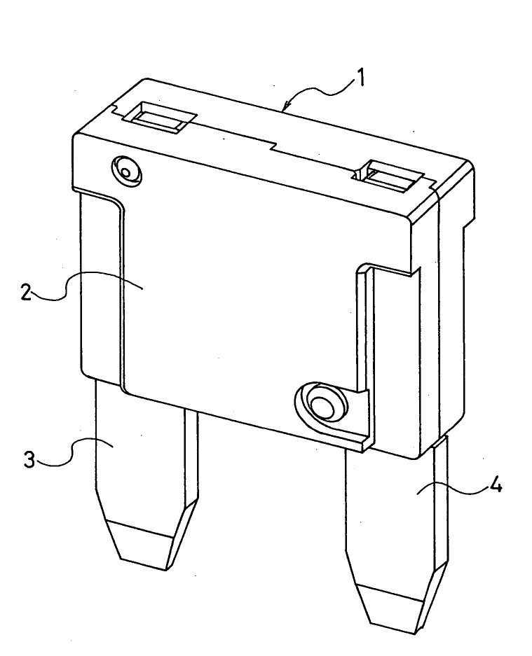

Obtained polyamide resin composition was vacuum-dried at 8° C. for ten hours after being pelletized to injection-mold a fuse housing part and ASTM test pieces shown in FIG. 1 at the cylinder temperature 250° C. and at mold temperature 40° C. and 70° C. respectively. Table 1 shows the evaluation results of properties of the fuse housing part and ASTM test pieces.

### EXAMPLE 2

Except that 0.1 part of talc by weight as a crystal nucleating agent (e: LMS-300 by Fuji Talc Industrial Co., Ltd.) was added, a polyamide resin composition was also prepared in the same manner as in Example 1 to injection-mold a fuse housing part and ASTM test pieces. Table 1 shows the evaluation results of them.

### EXAMPLE 3

A resin composition was obtained from a polyamide (c-2: nylon 6/66 copolymer with a relative viscosity of 2.75 measured at a concentration of 1% in concentrated sulfuric acid at 25° C., nylon 6 content of 95 weight %) and 3 part of swellable phyllosilicate by weight (b) obtained in the reference example 2 in the same manner as in Example 1 to injection-mold a fuse housing part and ASTM test pieces. Table 1 shows the evaluation results of their properties.

### EXAMPLE 4

Except that 0.1 part of talc by weight as a crystal nucleating agent (e: LMS-300 by Fuji Talc Industrial Co., Ltd.) was added, a polyamide resin composition of Example 4 was prepared in the same manner as in Example 3 to injection-mold a fuse housing part and ASTM test pieces. Table 1 shows the evaluation results of their properties.

### EXAMPLE 5

A polyamide resin composition was obtained in the same manner as in Example 1 from 90 part of polyamide by weight (c-1: nylon 6 with a relative viscosity of 2.70 measured at a concentration of 1% in concentrated sulfuric acid at 25° C.), 10 part of low-crystalline polyamide by weight (d-1) and 3 part of swellable phyllosilicate by weight (b) obtained in the reference example 2 to injection-mold a fuse housing part and ASTM test pieces. Table 1 shows the evaluation results of their properties.

### EXAMPLE 6

Except that 0.1 part of talc by weight as a crystal nucleating agent (e: LMS-300 by Fuji Talc Industrial Co., Ltd.) was added, a polyamide resin composition of Example 6 was prepared in the same manner as in Example 5 to injection-mold a fuse housing part and ASTM test pieces. Table 1 shows the evaluation results of their properties.

### EXAMPLES 7-9

Except that each material was used with the blending ratio shown in table 1, a polyamide resin composition was obtained in the same manner as in Example 1 to injection-mold a fuse housing part and ASTM test pieces composition. Table 1 shows the evaluation results of their properties.

### EXAMPLE 10

A resin composition was obtained to evaluate the properties in the same manner as in Example 1 by compounding 100 part of polyamide resin by weight (c-1), 3 part of phyllosilicate by weight (b) and 0.5 part of talc by weight as a crystal nucleating agent (e) used in the example 1 and also 0.2 part of N, N′-hexamethylenebis (3,5-di-tert-butyl-4-hydrocinnamamide) by weight (Toray Fine Chemicals Co., Ltd.) and 0.5 part of sodium hypophosphite by weight (Tokyo Kasei Kogyo Co., Ltd.). According to the evaluation of the properties, the diameter of spherulites was 0.08 μm, heat of fusion (40° C. molding) was 60 J/g, total light transmittance (initial value at 40° C.) was 90%, total light transmittance (during heat-treating) was 72%, load deflection temperature was 192° C. and arc resistance was 100 sec.

### COMPARATIVE EXAMPLE 1

Except that a swellable phyllosilicate (b) was not compounded, a polyamide resin composition was obtained in the same manner as in Example 1 to injection-mold a fuse housing part and ASTM test pieces. Table 2 shows the evaluation results of their properties.

### COMPARATIVE EXAMPLES 2-6

Except that each material used in examples was used with the blending ratio shown in table 2, a polyamide resin composition was obtained in the same manner as in Example 1 to injection-mold a fuse housing part and ASTM test pieces. Table 2 shows the evaluation results of their properties.

### COMPARATIVE EXAMPLE 7

Except that a swellable phyllosilicate (b) was not compounded, a polyamide resin composition was obtained in the same manner as in Example 8 to injection-mold a fuse housing part and ASTM test pieces. Table 2 shows the evaluation results of their properties.

Possibility for Industrial Use

The fuse for the automobile in the present invention can be used for varied electric parts for automobiles in the automobile industry. Especially, it can be effectively used for electric parts in the engine rooms under high temperature atmosphere.

TABLE 1

| | | | Exam- | Exam- | Exam- | Exam- | Exam- | Exam- | Exam- | Exam- | Exam- |
|---|---|---|---|---|---|---|---|---|---|---|---|
| | | | ple 1 | ple 2 | ple 3 | ple 4 | ple 5 | ple 6 | ple 7 | ple 8 | ple 9 |
| Polyamide (c-1) | | part by weight | 100 | 100 | | | 90 | 90 | 80 | 90 | 90 |
| Polyamide (c-2) | | part by weight | | | 100 | 100 | | | | | |
| Polyamide (c-3) | | part by weight | | | | | 10 | 10 | 20 | 10 | 10 |
| (b) Swellable phyllosilicate | | part by weight | 3 | 3 | 3 | 3 | 3 | 3 | 3 | 5 | 10 |
| (e) Talc | | part by weight | | 0.1 | | 0.1 | | 0.1 | | | |
| Diameter of spherulites | | μm | 0.08 | 0.08 | 0.08 | 0.1 | 0.08 | 0.08 | 0.1 | 0.2 | 0.2 |
| Heat of fusion | 40° C. molding | J/g | 53 | 60 | 48 | 50 | 50 | 53 | 44 | 51 | 51 |
| | Heat-processing | J/g | 56 | 63 | 50 | 51 | 52 | 54 | 47 | 52 | 51 |
| Total light | Initial value at 40° C. | % | 90 | 88 | 93 | 91 | 95 | 93 | 97 | 88 | 87 |
| transmittance | Heat-processing | % | 88 | 80 | 90 | 90 | 90 | 86 | 93 | 86 | 86 |
| | Mold temperature 70° C. | % | 84 | 82 | 86 | 85 | 88 | 86 | 90 | 83 | 81 |

| | | | | | | | | | | |
|---|---|---|---|---|---|---|---|---|---|---|
| Deflection temperature under load | ° C. | 190 | 192 | 180 | 182 | 185 | 188 | 181 | 189 | 193 |
| Dispersibility of clay | | ⊚ | ⊚ | ⊚ | ◯˜⊚ | ⊚ | ⊚ | ◯˜⊚ | ◯ | ◯ |
| Arc resistance | sec | 102 | 100 | 103 | 102 | 105 | 100 | 103 | 100 | 100 |

TABLE 2

| | | | Compara- | Compara- | Compara- | Compara- | | | |
|---|---|---|---|---|---|---|---|---|---|
| | | | tive | tive | tive | tive | Comparative | Comparative | Comparative |
| | | | example 1 | example 2 | example 3 | example 4 | example 5 | example 6 | example 7 |
| Polyamide (c-1) | | part by weight | 100 | 100 | | 90 | 80 | 20 | 20 |
| Polyamide (c-2) | | part by weight | | | 100 | | | | |
| Polyamide (c-3) | | part by weight | | | | 10 | 20 | 80 | 80 |
| (b) Swellable phyllosilicate | | part by weight | | | | | | | 3 |
| (e) Talc | | part by weight | | 3 | | | | | |
| Diameter of spherulites | | μm | 2 | 2 | 1.5 | 1.5 | 1.3 | 0.8 | 0.5 |
| Heat of fusion | 40° C. molding | J/g | 70 | 65 | 43 | 40 | 40 | 36 | 38 |
| | Heat-processing | J/g | 72 | 66 | 52 | 46 | 46 | 43 | 45 |
| Total light | Initial value at 40° C. | % | 55 | 55 | 68 | 90 | 92 | 97 | 95 |
| transmittance | Heat-processing | % | 42 | 40 | 60 | 70 | 72 | 82 | 82 |
| | Mold temperature 70° C. | % | 50 | 48 | 63 | 84 | 86 | 90 | 88 |

| | | | | | | | | |
|---|---|---|---|---|---|---|---|---|
| Deflection temperature under load | ° C. | 177 | 190 | 170 | 170 | 168 | 150 | 155 |
| Dispersibility of clay | | — | — | — | — | — | — | ◯˜Δ |
| Arc resistance | sec | 110 | 98 | 100 | 110 | 105 | 95 | 95 |

1. A fuse for an automobile comprising a housing manufactured by the injection molding of a polyamide resin composition, wherein the polyamide resin composition constituting the housing has a heat of fusion of 40 J/g or more, as measured by means of a differential scanning calorimeter, and exhibits an average diameter of spherulites of 0.5 μm or less, as measured by the observation by means of a polarization optical microscope.

2. A fuse for an automobile according to claim 1, wherein the rate of change in the heat of fusion, when heat-treating at 130° C. for 30 minutes a polyamide resin composition molded body that forms the housing obtained by injection-molding at a mold temperature of 40° C., is less than 15%.

3. A fuse for an automobile according to claim 1, wherein the total light transmittance of a polyamide resin composition molded body that forms the housing obtained by injection-molding at a mold temperature of 70° C. is 80% or more compared to the total light transmittance of a molded body obtained by injection-molding at a mold temperature of 40° C.

4. A fuse for an automobile according to claim 1, wherein a polyamide resin composition forming the housing is composed of a polyamide resin (a) and a swellable phyllosilicate (b).

5. A fuse for an automobile according to claim 4, wherein said polyamide resin (a) is at least one from the group of nylon 6, nylon 66 and copolymer or mixture of the two.

6. A fuse for an automobile according to claim 5, wherein said polyamide resin (a) is nylon 6.

7. A fuse for an automobile according to claim 4, wherein said polyamide resin (a) is composed of a mixture of crystalline polyamide (c) and low-crystalline or amorphous polyamide (d).

8. A fuse for an automobile according to claim 4, wherein the exchangeable positive ions existing between the layers of said swellable phyllosilicate (b) are swellable phyllosilicate exchanged with organic onium ions.

9. A fuse for an automobile according to claim 4, wherein said swellable phyllosilicate (b) is montmorillonite.

10. A fuse for an automobile according to claim 4, wherein said swellable phyllosilicate (b) is dispersed in the polyamide resin compositions on the monolayer level.

11. A fuse for an automobile according to claim 4, wherein said polyamide resin composition includes a crystal nucleating agent (e).

12. A fuse for an automobile according to claim 4, wherein said swellable phyllosilicate (b) is introduced in the polyamide resin composition by using a melt kneading method.

13. A fuse for an automobile according to claim 2, wherein the total light transmittance of a polyamide resin composition molded body that forms the housing obtained by injection-molding at a mold temperature of 70° C. is 80% or more compared to the total light transmittance of a molded body obtained by injection-molding at a mold temperature of 40° C.

14. A fuse for an automobile according to claim 2, wherein a polyamide resin composition forming the housing is composed of a polyamide resin (a) and a swellable phyllosilicate (b).

15. A fuse for an automobile according to claim 3, wherein a polyamide resin composition forming the housing is composed of a polyamide resin (a) and a swellable phyllosilicate (b).

16. A fuse for an automobile according to claim 13, wherein a polyamide resin composition forming the housing is composed of a polyamide resin (a) and a swellable phyllosilicate (b).
